(19) United States
(12) Patent Application Publication
(10) Pub. No.: US 2004/0030576 A1
(43) Pub. Date: Feb. 12, 2004

(54) Preventive examination system and method for operating same

(76) Inventors: Bernhard Montag, Bamberg (DE); Stefan Schaller, Furth (DE); Daniel Purwin, Rio de Janeiro (BR); Randy Scheff, Longwood, FL (US); Fionnuala Tennyson, Walton on Thames (GB)

Correspondence Address: SCHIFF HARDIN & WAITE, 6600 SEARS TOWER, 233 S WACKER DR, CHICAGO, IL, 60606-6473, US

(21) Appl. No.: 10/217,242

(22) Filed: Aug. 12, 2002

(51) Int. Cl. G06F 17/60

(52) U.S. Cl. 705/2

(57) ABSTRACT

In a method for the operation of a number of preventive examination centers and in a preventive examination system having a number of preventive examination centers the individual preventive examination centers are allocated to a franchise organization as franchise holders.

### BACKROUND OF THE INVENTION

1. Field of the Invention

The present invention is directed to a method for the operation of a number of preventive examination centers, as well as to a preventive examination system having a number of preventive examination centers.

2. Description of the Prior Art

Coronary heart diseases, lung cancer and colon cancer are currently among the most frequent causes of death within industrialized countries. Overall, more than 50% of the population in the industrialized world die because of these diseases. Imaging technologies such as computed tomography methods or nuclear magnetic resonance tomography methods that are available in the meantime inherently enable a relatively early recognition of these diseases, as a result the therapy prospects are considerably improved. There is therefore increasingly the trend to use modern imaging systems for the earlier recognition of such diseases even in persons who do not yet exhibit any symptoms whatsoever. Due to the relatively high costs, however, such examinations usually belong to the upper range of medical performance. Costs for such expensive, purely precautionary examinations of non-syntematic persons therefore usually are not paid by health insurers but must be paid for by the persons at their own expense. Thus, only a fraction of the population can afford such preventive examinations, even in highly industrialized countries.

Mainly in the USA, individual preventive examination centers have existed for some time, referred to as “screening centers”, that implements such preventive examinations with imaging methods. These are preventive examination centers founded by radiologists who are locally resident and who work on an individual basis. A medical equipment supplier supplies the required imaging examination systems, which are usually extremely expensive devices. The ongoing technical maintenance is usually likewise provided by the supplier of the devices. The users of the preventive examination centers, i.e. the persons who have a preventive examination carried out, usually pay directly to the respective preventive examination center. The fact that such preventive examination centers operate as individual undertakings has a number of disadvantages for the preventive examination centers themselves as well as for the users of these centers.

First, individually operating undertakings usually do not have the marketing resources in order to establish a recognized market name that assures the user of a high quality of the service provided. Moreover, there are no quality assurance standards whatsoever. The radiologists working at the examination center are confronted by the problem that they must invest some of their work in the management of the undertaking and cannot concentrate on their core competence, preparing diagnoses. From the point of view of the user, these problems ultimately can lead to a lack of trust with regard to the examination results that are obtained. Another disadvantage is that the data of a preventive examination often are not available as comparison data without greater outlay when the user later undertakes a further preventive examination in a different preventive examination center, for example after moving to a different city. Added thereto is that individual working preventive examination centers have a relatively high administrative outlay, particularly for the implementation of the accounting modalities with the users. Setting up such a preventive examination center represents a relatively high financial risk for the operators because of the high initial investments. All of this contributes to the high costs for the implementation of such preventive examinations.

### SUMMARY OF THE INVENTION

An object of the present invention is to provide a method for the operation of a number of preventive examination centers and a preventive examination system having a number of preventive examination centers, wherein the aforementioned disadvantages are avoided or at least reduced and, in particular, the possibility is created of offering more economical preventive examinations.

This object is achieved according to the invention in a preventive examination system and a method for operating a preventive examination system, having a number of preventive examination centers that are allocated to a franchise organization as franchise holders.

Such a preventive examination system having a number of preventive examination centers allocated to a franchise organization has substantially better possibilities of operating an efficient, economical marketing than a single preventive examination center. In particular, a mark (i.e. a trademark) that is known inter-regionally can be created in this way, thereby promoting the trust of the users in the preventive examinations since the mark stands for a high quality standard. Preventive examination centers that are newly opened can achieve the desired economic success relatively fast with minimum outlay as a result of suitable marketing material and on the basis of a predetermined marketing strategy. In particular, radiological practices that are already in operation can join the franchise organization as preventive examination center without great financial risk, for example on a trial basis. As a shared marketing feature, for example, the franchise organization can publish a central web portal, a user newsletter or even a magazine with interesting, particularly medical topics that is regularly sent to the users. Additionally, there is the possibility for the franchise organization to perform financial services with respect to the individual preventive examination centers, for example on the basis of leasing the required examination systems. All of these measures lead to a more beneficial cost structure of the individual preventive examination centers as well as to less of a financial risk because of usage that can be calculated, this being reflected directly in the costs that are billed to the users for the preventive examinations. The preventive examinations thus can be more economically offered, so that broader segments of the population can afford these potentially life-saving preventive measures.

In addition, the inventive operating method and preventive examination system offer the possibility of an economical training and fast transfer of know-how. Continuing education courses specifically required for preventive examinations can be offered, for example by the franchise organization on a particularly for the personnel of newly established preventive examination centers. The allocation to a higher-ranking franchise organization also makes it possible for the individual preventive examination centers—particularly in cases of doubt—to have a second, independent finding of examination data carried out by particular specialists or by radiologists of a different preventive examination center without greater outlay and in a relatively inexpensive. An enhanced diagnostic reliability thus can be offered to the user. Further possibilities arise due to the set-up of a shared user databank that, for example, also allows the franchise organization to remind the users of follow-up dates for further preventive examinations.

In a preferred embodiment, the preventive examination centers respectively have at least one computer device. The respective computer devices of the preventive examination centers are connected to one another and/or to a computer device of the franchise organization via a communication network. Examination data and/or accounting data and/or user authorization data and/or standardization data can be communicated via this communication network between the individual preventive examination centers and/or between the preventive examination centers and the computer device of the franchise organization.

The Internet and/or an Intranet of the franchise organization can be employed as the communication network. An Internet-based networking of the individual preventive examination centers and the franchise organization is relatively inexpensive. However, it is also possible to set the connection up individually as a point-to-point connection, for example via a telephone network, whereby dedicated lines or connections that are installed for the individual case can be employed dependent on the extent of the utilization.

Particularly when a public communication network like the Internet is employed, the computer devices of the preventive examination centers and of the franchise organization advantageously have encryption devices in order to encrypt person-related data before a communication thereof via the communication network.

In a preferred embodiment, the accounting of the preventive examinations with the users ensues via the franchise organization. In one possible model the users regularly pays a type of “membership contribution” to the franchise organization. The individual preventive examination centers then settle accounts with the franchise organization after carrying out an examination, i.e. they receive their fee from the franchise organization. This reduces the administrative costs for the accounting on the part of the preventive examination centers to a substantial extent. Preferably, the computer device of the franchise organization are operable for checking a usage authorization of the individual users for this purpose. For example, a check can be made to determine whether the user is a customer of the franchise organization, has regularly paid the contribution and whether user still has a right for examination performances within a specific accounting time span. Additionally, the computer device of the franchise organization can generate user authorization data dependent on the check that has been performed as well as sending user authorization data to the preventive examination centers. This sending of the user authorization data can ensue regularly, for example by sending a membership databank wherein the authorized users are listed, or by sending updates of this databank to the preventive examination centers. Alternatively, the usage authorization can be checked online for specific user on demand of an examination center. The computer devices of the preventive examination centers each allow authorization of a user on the basis of the user authorization data that are received, for example by comparing the received user authorization data to the data of a customer card presented by the user.

Preferably after an examination of the authorized user, the preventive examination center also communicates accounting data to the computer device of the franchise organization. These accounting data also contain more precise information about the nature and scope of the implemented examination in addition to including the information about the user. The computer devices of the preventive examination centers each generate accounting data dependent on an examination that has ensued and for communicating such accounting data to the computer device of the franchise organization. On the basis of the accounting data, the franchising organization can then automatically prepare a reckoning with respective preventive examination center so that the appertaining preventive examination center receives the fee for the examination. The accounting data also can be used when the payment modalities between the franchise organization and the examination center provide a case-dependent franchise payment of the preventive examination centers to the franchise organization (pay-per-use method) and/or when the examination systems were made available to the respective preventive examination center by the franchise organization and the preventive examination center pays fees to defranchise organization for the individual use.

Further, there is the possibility to communicate examination data of a prior examination of a particular user for the examination of that user at an examining preventive examination center, from a different preventive examination center and/or from the computer device of the franchise organization. The current examining preventive examination center thus can have recourse to existing, older comparison data for better diagnosis independently of whether the user had already been examined once thereat.

It is likewise possible for the examining preventive examination center communicates examination data of the user to a different preventive examination center and/or to the computer device of the franchise organization for evaluation in an examination of a user. For example, a second opinion can be obtained in this way by personnel of a different preventive examination center. This is particularly useful when radiologists in different preventive examination centers have specific expertise in a particular field and are considered experts in this field. The other preventive examination centers then have the possibility of having recourse to this specific expert knowledge in an uncomplicated way, for example for a fee that can likewise be billed via the franchise organization.

Further, it is possible for the franchise organization to offer a computer-assisted remote diagnosis on a computer device. The preventive examination centers then can send their examination data in via the communication network and get the diagnosis back in the same way in the shortest possible time.

For sending examination data, the computer devices preferably are connected to an examination device of the appertaining preventive examination center via a data line. The computer devices thus can directly accept the examination data, process the data and sent the processed data to the appertaining locations.

To this end, the computer devices respectively receive examination data from the examination device and link the examination data to further data that relate to the examination and/or to the examined user. These further data can, for example, be other examination data such as weight, height, blood pressure, an ECG of the user or further images from other imaging systems. The further data also can be background data such as age or sex of the user, or findings, inquiries or instructions of the examination personnel. Moreover, the computer device can communicate the examination data in common with the further data to a computer device of the franchise organization or of some other preventive examination center via the communication network. This means that all data relevant for the respective examination case are merged and sent to the appertaining location that is to process or store these data.

The computer device of the franchise organization preferably has a databank wherein all examination data of the respective users registered by the preventive examination centers of the franchise organizations are stored allocated to the users, so that the individual preventive examination centers can have recourse to this as needed.

In a preferred embodiment, the computer device of the franchise organization communicates standardization data to the preventive examination centers for the standardization of specific examination procedures, i.e. for example, the optimum setting data of the examination systems for specific examination instances are communicated to the individual preventive examination centers, so that these can employ the data for their examinations. The standardization data also can contain prescribed parameters that are to be employed for interpretations of examination data in order to obtain an optimum result. Additionally, the standardization data can contain guidelines, checklists, etc., with which the preventive examination centers or their personnel are exactly instructed as to how specific examinations are to be implemented. In this way, care can be exercised to insure that all preventive examination centers offer the same high standard as prescribed by the franchise organization and guaranteed to the user.

In order to assure that these standards are adhered to, there is preferably the possibility for the preventive examination centers to communicate check data to the computer device of the franchise organization either continuously or at time intervals. The franchise organization can undertake a remote monitoring of the preventive examination centers in this way. The check data can, for example, be co-logged examination data and/or data about the course of the examination. Given a non-continuous transmission of the check data, such data can be sent at regular time intervals or can be communicated by being called by the computer device of the franchise organization in the fashion of a spot check. To this end, the computer devices of the preventive examination centers can, for example, includes a logging device with an intermediate memory that permanently co-logs all relevant data and stores this log for a specific time, so that it can be called by the franchise organization at any time.

In addition to these tools for assuring the quality standard of the implemented examinations via the communication network, the franchise organization also can implement centrally coordinated user surveys or even audits on site in the respective examination centers.

The standards such as, for example, specific examination procedures and findings that are to be implemented in the preventive examination centers can, for example, be defined by an advisory board. Such an advisory board can, for example, can be composed of a number of particularly prominent radiologists who are known to the general public as leading scientists or medical practitioners in this field. The advisory board can be represented by a spokesperson who is especially well-known to the public. As a result, especially high trust in the examination of the preventive examination centers belonging to the franchise organization is created. As an additional measure, a specific portion of the revenue of the franchise organization can be contributed to research institutions that have specialized in the continuing development of preventive examinations.

### DESCRIPTION OF THE DRAWINGS

FIG. 1 schematically illustrates an organizational structure of the prior art.

FIG. 2 schematically illustrates the organizational structure given an exemplary embodiment of an inventive preventive examination system.

FIG. 3 schematically illustrates the networking of the individual preventive examination centers with the franchise organization in accordance with the invention.

FIG. 4 illustrates an exemplary embodiment of a computer device of a preventive examination center for the inventive preventive examination system.

FIG. 5 schematically illustrates an exemplary embodiment of a computer device of the franchise organization for the inventive preventive examination system.

### DESCRIPTION OF THE PREFERRED EMBODIMENTS

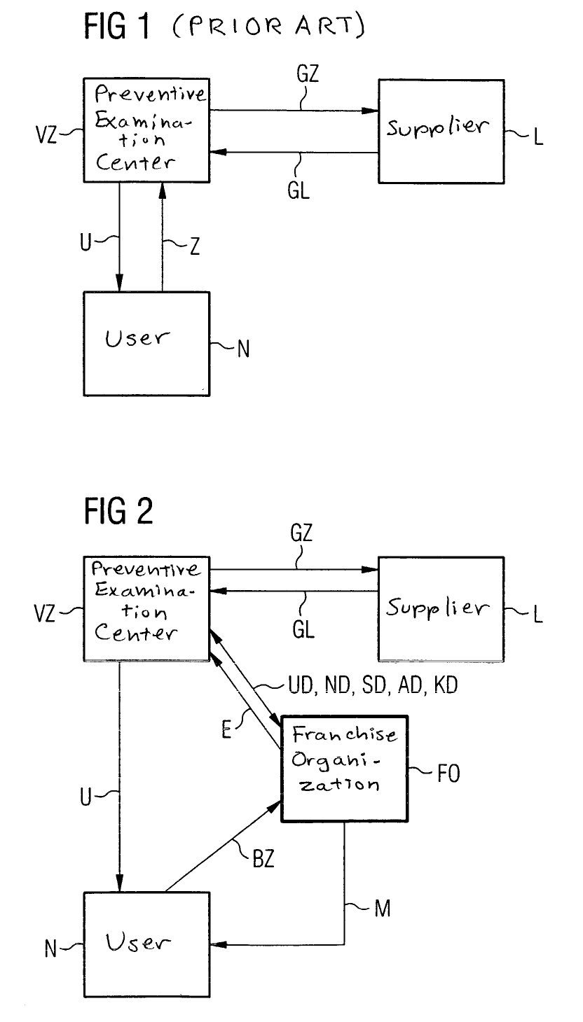

Heretofore, preventive examination centers have been organized as independent undertakings, as shown in FIG. 1. This preventive examination center VZ carries out an examination U at a user N, and a payment Z by the user N directly to the preventive examination center VZ ensues. The device delivery GL of the necessary examination systems or, respectively, installations ensues by means of a supplier L who is directly commissioned by the preventive examination center VZ. Likewise, the device payment GZ ensues directly from the preventive examination center VZ to the supplier L. Devices such as compute tomography systems or magnetic resonance tomography systems, x-ray devices, etc. required for the examination are a matter of extremely expensive components. It is therefore clear that a preventive examination center VZ that is on its own as an individual undertaking bears an extremely high risk from an entrepreneurial point of view, to insure that the devices are also adequately used and the payments Z of the users N ensue in timely fashion, so that the preventive examination center VZ can maintain its obligations of device payment GZ with respect to the supplier L. This increased risk is reflected in the cost structure of the individual preventive examination center VZ either directly, for example due to higher interest costs for the financing of the device, or indirectly, which ultimately leads to higher costs for a individual preventive examinations U.

As shown in FIG. 2, the preventive examination center VZ is allocated to a franchise organization according to the present invention. This franchise organization FO uses corresponding marketing measures to see to a better usage of the preventive examination centers VZ connected to it. Among other things, marketing information M are given to the user N for this purpose, for example via the Internet or in the form of public relation activities or the like. The users N go for a preventive examination U to one of the preventive examination centers VZ which then perform the examination service U at the respective user N.

In order to relieve the preventive examination centers VZ of the administrative outlay for collecting the payment Z of the user, in the illustrated exemplary embodiment the users N who wish to have preventive examinations regularly implemented by the preventive examination centers VZ send a contribution payment BZ to the franchise organization FO at specific time intervals, for example, monthly, semi-annually or annually. The franchise organization FO in turn sees to indemnification payments E to the preventive examination centers VZ for the respectively implemented preventive examinations.

Arbitrary examination data UD, accounting data AD, user authorization data ND, standardization data SD or monitoring data FD can be communicated back and forth between the preventive examination centers VZ and the franchise organization FO, the individual preventive examination centers VZ and the franchise organization FO mutually informing and assisting one another with these. The communications of all of all of these data via a computer network CN, for example the Internet or an internal Intranet of the organization.

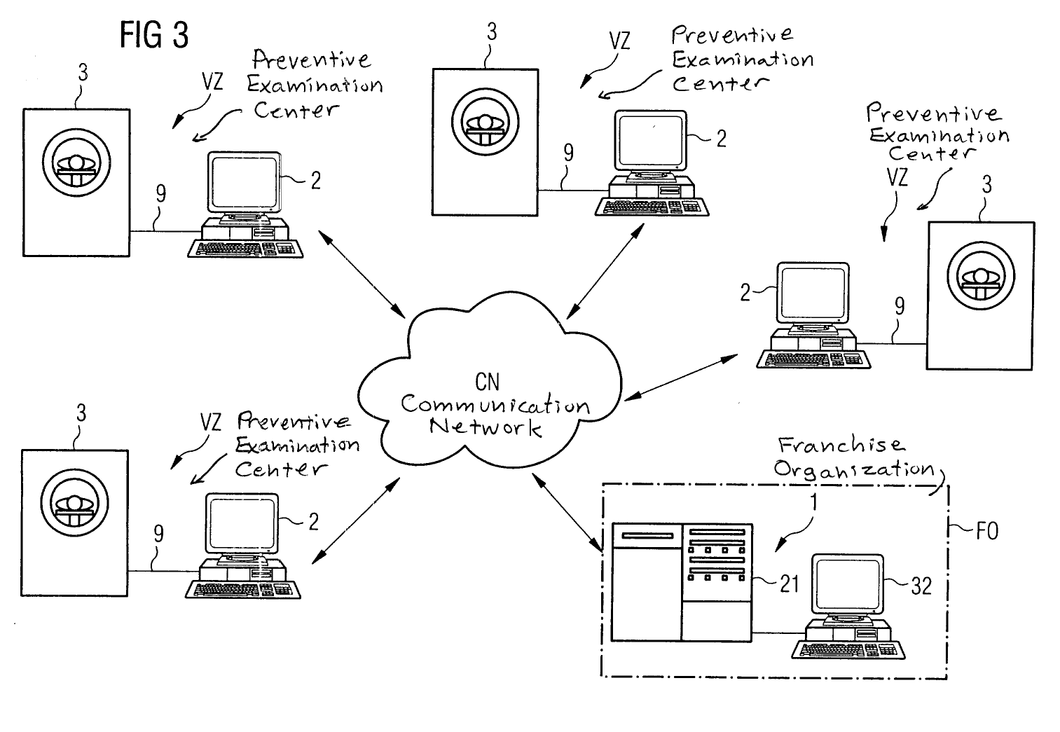

To this end, the individual preventive examination centers VZ are equipped with computer units 2 that are connected to the computer network CN. This is shown in FIG. 3. Likewise, a computer unit 1 of the franchise organization is connected to the computer network CN. As can likewise be seen from FIG. 3, the computer units 2 of the preventive examination centers VZ are respectively connected via data lines 9 to the examination device 3 that is employed.

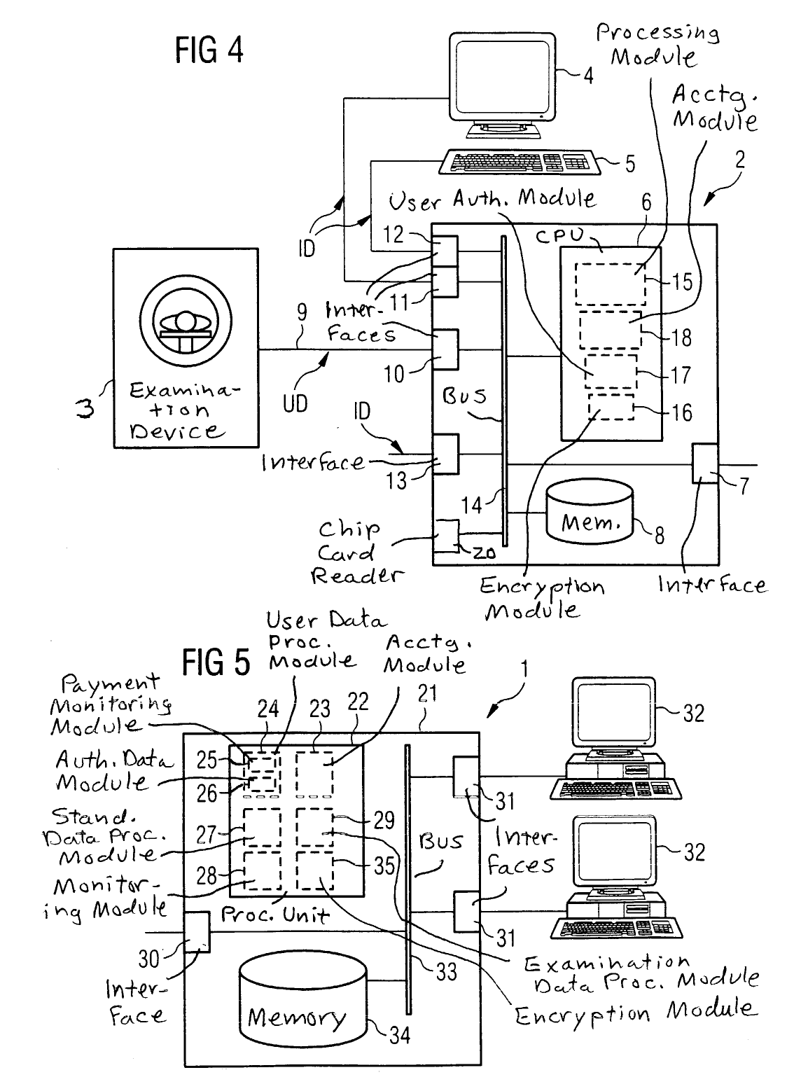

The individual computer units 2 of the preventive examination centers are shown again in greater detail in FIG. 4 and the computer unit 1 of the franchise organization FO is shown in greater detail again in FIG. 5.

The computer device 2 of the preventive examination center VZ in the exemplary embodiment shown in FIG. 4, is a conventional computer suitably designed with respect to its performance capability and equipped for the implementation of the inventive method by appropriate hardware components such as, for example, various specific interfaces and software components such as different software modules. Dependent on the size and equipment of the preventive examination center VZ, the computer unit 2 can be a simple, suitably configured PC or can also be a local network of individual computers.

In detail, the computer unit 2 in FIG. 4 has an interface 10 for the connection of the examination device 3 via a data line 9, via which examination data, for example, image data of the registered images, can be communicated to the computer unit 2. A keyboard 5 and a picture screen 4 for the operation of the computer unit 2 are connected to the computer unit 2 via further interfaces 11, 12.

The computer device 2 can be connected to the computer network CN via a network termination interface 7, for example an ISDN card. Further interfaces, whereof only one interface 13 is shown here, are present in order to connect the computer unit 2 to other examination devices, for example an ECG device or other imaging examination systems. Alternatively, it is possible to connect all devices to one another via a bus system.

The computer device 2 is connected to a card leader device 20 via an interface 19 in order to read and examine customer cards of users N who wish to undergo a preventive examination. A memory 8 as well as a CPU 6 on which various program modules are implemented are also situated in the computer device 2. All interfaces 7, 10, 11, 12, 13, 19, the CPU 6 as well as the memory 8 are connected to one another via a bus 14. The individual computers and examination devices of the preventive examination center can form a conventional radiological information system (RIS) and/or an image archiving and communication system (PACS, picture archiving and communication system).

The following, specific software modules are shown within the CPU in FIG. 4:

An examination data processing module 15 in order, for example, to process examination data of a user as well as further data of the user and link them to one another;

An accounting module 18 for producing accounting data following an examination;

An encryption module 16 for encrypting person-related data before being sent via the computer network;

A user authorization module 17 for authorizing a user before an examination.

The functioning of these modules shall be explained below.

The computer unit 1 of the franchise organization FO according to FIG. 5 is a server 21 that is appropriately designed in terms of its capacity and is equipped with the hardware and software components required for the present, inventive function. Instead of an individual server 21, of course, a suitable computer network can also be utilized here. Various terminals 32 with which the operating personnel of the franchise organization FO can enter control commands and data required within the method, or read-out data and/or process data are connected to the server 21 via corresponding interfaces 31.

In addition to the interfaces 31 for the connection of the terminals 32, the server 21 has a network termination interface 30 for connection to the computer network GN. An adequately large bulk storage 34 and a processing unit 22 on which the required software modules are implemented are also situated within the server 21. All of these components are again connected to one another via a bus 33. As software modules, a user data processing module 24, an accounting module 23, a monitoring module 28, a standardization data processing module 27, an examination data processing module 29 and an encryption module 35 are shown on the processor unit 22.

Of course, both the computer device 2 of the preventive examination centers VZ as well as the computer device 1 of the franchise organization FO have all other components that are usually present in such computer devices such as, for example, further processors for parallel assumption of particularly time-consuming calculating operations, additional temporary or permanent stores or, respectively, means for storing data on portable data carriers, a connection to a printer or the like for printing out data, etc. None of these components are shown here for clarity. The same is true of the software usually installed on such computer devices such as operating systems, picture screen and keyboard drivers, interface drivers, etc.

It should be noted here that the computer units 2, 1 of the preventive examination centers VZ and of the franchise organization FO according to FIGS. 4 and 5 are only exemplary embodiments and that some arbitrary, other computer architecture can be selected. Instead of only one computer unit 2, 1—particularly at the side of the franchise organization—, the computer devices can be a number of servers or the like networked with one another.

The individual software and hardware components of the computer device 2 of the preventive examination centers VZ as well as the computer device 1 of the franchise organization FO collaborate with one another in the following way:

The user data within a user data bank that is stored in the memory 34 are regularly monitored to within the user data processing module 24. In particular, a check is carried out within a payment monitoring module 25 to determine whether the individual users N have regularly made their contribution payments VZ. On the basis of this check, authorization data AD for the respective user N are then generated within the authorization data module 26, these, for example, containing information about which services the user N enjoys overall and which services have already been carried out, or which services the user is still entitled to at the specific point in time. These user authorization data are deposited within the user data bank, so that such data are always up-to-date.

When a user N arrives at the preventive examination center VZ and asks for a preventive examination, the preventive examination center VZ registers the data of the user N. This can occur, for example, with the assistance of a chip card that is read in a chip card reader device 20. The data are then handed over to a user authorization module 17 that, for example, first checks the identity of the user by inputting a secret number at the chip card reader device 20 and then sends the data to the computer device 1 of the franchise organization FO for review. The computer device 1 queries the user authorization data ND deposited in the user data bank for the user N and sends these to the computer device 2 of the preventive examination center VZ. On the basis of these user authorization data ND, the user authorization module 17 then authorizes the user for the respectively desired preventive examination, i.e. an appropriate message is output to the operating personnel of the preventive examination center VZ to the effect that the preventive examination can be implemented.

Subsequently, the desired preventive examination is implemented in the preventive examination center VZ by means of the examination device 3. The examination data UD are communicated via the data line 9 and the interface 10 to the computer device 2. For example, a linking ensues to the personal data of the user N determined based on the chip card. Moreover, the operating personnel can input further data ID or comments, for example findings, via the keyboard 5 or via a graphic user interface on the picture screen 4. It is likewise possible to link additional data ID from other examination devices that are connected to the interface 13, for example data of an ECG, with the examination data UD of the examination device 3. The examination data generated by the examination device 3 can thereby be displayed at any time on the picture screen 4, for example, for the analysis of the examination result by a radiologist.

The overall examination data UD can then be communicated together with the further data ID to the computer unit 1 of the franchise organization FO via the computer network N and can be deposited thereat in the user databank for the respective user N. The examination data arriving at the computer 1 of the franchise organization FO are suitably processed in an examination data processing module 29 and are delivered to the user databank within the memory 34.

On demand, a computer-assisted diagnosis can be generated with appropriate software (not shown) and can be returned to the preventive examination center VZ. Moreover, examination data UD of the respective user from preceding preventive examinations can be fetched at any time from the user databank by the computer device 2 of the preventive examination center as comparison data and can be displayed on the picture screen 4.

After an examination, moreover, accounting data AD are generated within the computer 2 in an accounting module 18 and are sent to the computer device 1 of the franchise organization via the computer network CN. This likewise has a suitable accounting module 23 and further-processes the data AD, so that a proper accounting between the franchise organization FO and the respective preventive examination center VZ is implemented.

Encryption modules 16, 35 are respectively installed on the computer unit 2 of the individual preventive examination centers VZ as well as on the computer unit 1 of the franchise organization FO in order to reliably encrypt person-related data before these data are sent via the computer network.

Additionally, the standardization data processing module 27 is implemented in the computer device 1 of the franchise organization, specific standardization data SD being capable of being input thereat, for example via the terminals 32, as parameters for specific examinations, etc. These standardization data SD are then sent as prescriptions to the individual preventive examination centers VZ, so that these implement specific examinations with the prescribed parameters. The standardization data SD also can contain guidelines that are communicated to the preventive examination centers and that can be used thereat, for example by operating personnel, as a type of handbook or checklist for the implementation of specific examinations. In particular, the standardization data SD can include entire work sequences that are to be implemented in sequence for a specific examination and, for example, are checked by the computer device 2 of the respective preventive examination center VZ by checking the work sequences at the individual examination devices 3.

This monitoring module 28 in the computer device 1 of the franchise organization can check the communicated examination data UD at any time for adherence to the standardization data SD.

In another version that is not shown a logging device, for example in the form of a software module having a suitable memory, is installed within the computer device 2 of the preventive examination centers VZ, this logging device permanently co-logging the events and work sequences or, respectively, their critical data within the preventive examination center VZ. The data can be fetched at any time by the monitoring module 28 of the computer device 1 in order to assure adherence to the standards in the preventive examination centers VZ.

Although modifications and changes may be suggested by those skilled in the art, it is the intention of the inventor to embody within the patent warranted hereon all changes and modifications as reasonably and properly come within the scope of the inventor's contribution to the art.

We claim as our invention:

1. A method for operating a plurality of preventive examination centers, comprising the steps of:
creating a franchise organization; and
allocating the preventive examination centers to said franchise organization as respective franchise holders.

2. A method as claimed in claim 1 comprising the additional steps of:
establishing a communication network among said preventive examination centers; and
exchanging data selected from the group consisting of examination data, accounting data, user authorization data and standardization data among said preventive examination centers via said communication network.

3. A method as claimed in claim 2 comprising employing the Internet as said communication network.

4. A method as claimed in claim 2 comprising employing an Intranet as said communication network.

5. A method as claimed in claim 2 comprising conducting a preventive examination of a user at a first point in time at a first of said preventive examination centers, and thereby producing examination data for said user;
conducting a preventive examination of said user at a second of said preventive examination centers at a second point in time following said first point in time; and
communicating said examination data for said user from said first of said preventive examination centers to said second of said examination centers via said network.

6. A method as claimed in claim 2 comprising conducting a preventive examination of a user at a first of said preventive examination centers and thereby generating examination data for said user at said first of said examination centers; and
transmitting said examination data for said user via said network from said first of said preventive examination centers to a second of said preventive examination centers, and evaluating said examination data for said user at said second of said preventive examination centers.

7. A method as claimed in claim 1 comprising providing a computer at said franchise organization;
establishing a communication network between each of said preventive examination centers and said computer at said franchise organization; and
transmitting data selected from the group consisting of examination data, accounting data, user authorization data and standardization data between said preventive examination centers via said network and via said computer at said franchise organization.

8. A method as claimed in claim 7 comprising employing the Internet as said communication network.

9. A method as claimed in claim 7 comprising employing an Intranet as said communication network.

10. A method as claimed in claim 7 comprising the steps of:
identifying a user requesting a preventive examination at one of said preventive examination centers; and
transmitting user authorization data for said user from said computer at said franchise organization to said one of said preventive examination centers.

11. A method as claimed in claim 7 comprising the steps of:
conducting a preventive examination of a user at one of said preventive examination centers, and thereby generating accounting data for said preventive examination of said user; and
transmitting said accounting data from said one of said preventive examination centers to said computer at said franchise organization.

12. A method as claimed in claim 7 comprising the steps of:
conducting a first preventive examination of a user at a first point in time at a first of said preventive examination centers, and thereby generating examination data for said user at said first of said preventive examination centers;
conducting a second examination of said user at a second point in time, following said first point in time, at a second of said preventive examination centers; and
transmitting said examination data for said user from said first of said examination centers to said second of said examination centers via said network and via said computer at said franchise organization.

13. A method as claimed in claim 7 comprising the steps of:
conducting a preventive examination of a user at a first of said preventive examination centers, and thereby generating examination data for said user at said first of said preventive examination centers;
transmitting said examination data for said user from said first of said preventive examination centers to a second of said preventive examination centers via said network and via said computer at said franchise organization; and
evaluating said examination data for said user at said second of said preventive examination centers.

14. A method as claimed in claim 7 comprising generating standardization data at said franchise organization for standardization of specific examination procedures; and
communicating said standardization data from said computer at said franchises organization to each of said preventive examination centers via said network.

15. A method as claimed in claim 7 comprising the steps of:
generating monitoring data at each of said preventive examination centers; and
communicating said monitoring data from each of said preventive examination centers to said franchise organization via said network in a communication mode selected from the group consisting of continuous communication and communication at time intervals.

16. A preventive examination system comprising:
a plurality of preventive examination centers allocated to a franchise organization as franchise holders;
each of said preventive examination centers having a computer and said franchise organization having a computer; and
a communication network connected to each of the computers at the respective preventive examination centers and the computer at the franchise organization.

17. A preventive examination system as claimed in claim 16 wherein said communication network comprises the Internet.

18. A preventive examination system as claimed in claim 16 wherein said communication network comprises an Intranet.

19. A preventive examination system as claimed in claim 16 wherein each of said preventive examination centers further comprises an examination device, and wherein each preventive examination center further comprises a data line connecting the computer and the examination device in that preventive examination center.

20. A preventive examination system as claimed in claim 19 wherein each computer device in each of said preventive examination centers receives examination data from the examination device in that preventive examination center via said data line, links said examination data with further data, to form linked data, and communicates said linked data to at least one of said computer device at said franchise organization and a computer device at another of said preventive examination centers.

21. A preventive examination system as claimed in claim 20 wherein said computer links said examination data with additional examination data, as said further data, to form said linked data.

22. A preventive examination system as claimed in claim 20 wherein said computer links said examination data with data relating to a user examined using said examination device, as said further data, to form said linked data.

23. A preventive examination system as claimed in claim 16 wherein said computer device at said franchise organization receives information identifying a user via said network from one of said preventive examination centers, checks a user authorization of said user, generates user authorization data dependent on the check, and transmits said user authorization data via said network to said one of said preventive examination centers, and wherein said computer at said one of said preventive examination centers determines whether examination of said user at said one of said examination centers is authorized dependent on said user authorization data.

24. A preventive examination system as claimed in claim 16 wherein each computer at each of said preventive examination centers generates accounting data dependent on an examination at that preventive examination center, and transmits said accounting data to said computer at said franchise organization via said network.

25. A preventive examination system as claimed in claim 16 wherein the respective computers of said preventive examination centers and the computer at said franchise organization each has an encryption device for encrypting selected data before transmitting said data via said communication network.
